(19) United States
(12) Patent Application Publication
(10) Pub. No.: US 2011/0255606 A1
(43) Pub. Date: Oct. 20, 2011

(54) SPATIAL NOISE REDUCTION CIRCUIT AND APPROACH THEREFOR

(76) Inventor: Olukayode A. Ojo, Gest (NL)

(21) Appl. No.: 13/062,135

(22) PCT Filed: Sep. 4, 2009
(86) PCT No.: PCT/IB2009/053855

§ 371 Date: Jul. 8, 2011

Related U.S. Application Data
(60) Provisional application No. 61/094,322, filed on Sep. 4, 2008.

(51) Int. Cl. H04N 7/26; G06K 9/40

(52) U.S. Cl. 375/240.24; 382/260; 382/264; 375/E07.027; 375/E07.193

(57) ABSTRACT

Video data is processed according to grid-based characteristics. According to an example embodiment of the present invention, regions of an image centered on a horizontal and/or vertical grid are identified. For each of these regions, video data representing central sub-regions therein is filtered to mitigate blocking artifacts. These approaches may be carried out upon regions including a block of pixels, with central sub-regions including a centrally-located pixel and other pixels adjacent thereto. These approaches may also be carried out on video data such as a compressed bitstream, with aspects of the grid identification and filtering based on one or both of the compressed bitstream and decoded data therefrom.

### PRIORITY INFORMATION

This patent application claims priority from PCT patent application PCT/IB2009/053855 filed Sep. 4, 2009, which claims priority to U.S. Provisional Application No. 61/094,322 filed Sep. 4, 2008, both of which are hereby incorporated by reference.

### BACKGROUND OF THE INVENTION

The present invention relates generally to video processing, and to systems and methods for providing mitigating noise and/or blocking artifacts in video images. Video images are susceptible to a variety of undesirable noise and/or artifacts, which can result from characteristics of video data processing and displays used to display an image corresponding to the video data. For instance, video data is often compressed or otherwise processed for transmission, and then decompressed or otherwise processed for display. In addition, video data is often up-scaled or otherwise configured for use in generating an image on a particular type of display.

Noise reduction of image data has been realized using spatial and/or temporal filters that are based upon averaging likely-correlated picture elements. For the reduction of coding artifacts spatial or temporal filters have been used. These filters are generally designed specifically to reduce blocking artifacts or ringing, and are often based on detecting the edges of the blocks. However, previous approaches are susceptible to generating video exhibiting undesirable noise and/or artifacts, where image sharpness and quality is preserved.

These and other issues remain challenging to processing video for display, and in particular to presenting video images that are relatively noise and/or artifact-free. Various aspects of the present invention are directed to methods and systems for processing video in a manner that addresses challenges including those discussed above.

### SUMMARY OF THE INVENTION

Example embodiments of the present invention are directed to pre-filtering video data by identifying, from within the video data, image regions such as pixel blocks that are centered upon one or more grids in the image, and by pre-filtering the identified regions to mitigate blocking artifacts that may be associated with the regions.

According to another example embodiment, video data representing images characterized by horizontal and vertical grids is processed as follows. For each image, a block grid detector is used to identify regions of the image that are centered on a horizontal grid or on a vertical grid. For each of the identified regions, video data representing central sub-regions therein is filtered to mitigate blocking artifacts.

According to another example embodiment, a system processes video data representing images characterized by horizontal and vertical grids. The system includes a block grid detector arrangement and a filter. The block grid detector arrangement identifies regions of each image that are centered on a horizontal grid or on a vertical grid. The filter arrangement filters video data representing central sub-regions within each identified region to mitigate blocking artifacts therein.

In a more particular example embodiment, a video processing system processes a compressed video bitstream for video data characterized by horizontal and vertical grids. A block grid detector arrangement identifies horizontal and vertical grids from the bitstream, decodes the bitstream, and outputs decoded video data together with information characterizing the identified grids. A spatial analyzer detects artifact conditions for each pixel block centered on one of the identified grids. A pre-filter arrangement uses the identified grids and detected artifact conditions to pre-filter the pixel blocks that centered on a grid in order to mitigate blocking artifacts therein. A secondary filter arrangement receives an output from the pre-filter arrangement and filters the decoded pre-filtered video data. That is, the secondary filter arrangement filters video data corresponding to the decoded video data, with certain data corresponding to the aforesaid centered pixel blocks being replaced with the filtered data.

The above summary is not intended to describe each embodiment or every implementation of the present disclosure. The figures and detailed description that follow more particularly exemplify various embodiments.

### BRIEF DESCRIPTION OF THE DRAWINGS

The invention may be more completely understood in consideration of the following detailed description of various embodiments of the invention in connection with the accompanying drawings, in which:

FIG. 1 shows a system for filtering video data, according to an example embodiment of the present invention;

FIG. 2 shows another system for filtering video data, according to another example embodiment of the present invention; and

FIG. 3 shows a video processing and display system for multi-stage, grid-based filtering of incoming video data, according to another example embodiment of the present invention.

### DETAILED DESCRIPTION OF THE INVENTION

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined in the claims. The present invention relates to systems and methods for processing video in a manner that mitigates noise and/or blocking artifacts. While the present invention is not necessarily limited to such approaches, various aspects of the invention may be appreciated through a discussion of examples using these and other contexts.

In connection with various example embodiments, a video data processing approach involves mitigating white noise having Gaussian distribution and digital coding artifacts such as blocking, ringing and mosquito noise. This approach involves identifying regions of an image having a smaller centrally-located sub-region therein located at one or more grid lines of the image. In some applications, these regions include a plurality of pixels (e.g., a block of pixels), and the sub-regions include one (or a few) of the pixels located near the center of the plurality of pixels or pixel block. In some embodiments, this integrated approach is used for processing digitally encoded signals that have been converted from previously-transmitted signals of analog origin. This approach is also applicable to processing a variety of video types, including the processing of bitstream video data.

According to another example embodiment, a block grid detector is used to identify information about the position of the horizontal and the vertical grid for an image, and about the size and the offset of the grid for vertical and horizontal directions of the image. This information is used to mark the pixels in the image, on which an additional low pass filtering is applied in the following manner. For a given pixel, which is marked as positioned on a vertical grid and its direct neighboring pixels on the same line, a horizontal low pass filter is applied. Similarly, a vertical low pass filter is applied to the pixels marked as positioned on a horizontal grid and to their direct neighboring pixels on the previous line and the next line of the image. The low pass filtered pixels are used to replace the appropriate pixels of the neighborhood of pixels (e.g., as used in a discriminating averaging filter).

In some embodiments, this horizontal and vertical low-pass filtering approach is carried out to pre-filter a center pixel and only the direct neighboring pixels of a region in an image, when the centre pixel is situated on a horizontal or a vertical grid of the image. This approach facilitates a reduction of blocking artifacts, while preserving small details due to limiting the pre-filtering approach to the center (and surrounding) pixels. That is, pixels located near an edge of such a region are not processed via such low-pass filtering, maintaining sharpness and details corresponding therewith.

Various circuits, devices and/or software (and corresponding algorithm) approaches can be used to effect the grid detection and filtering as discussed above. For instance, a block grid detection approach that may be amenable to implementation with the present invention is described in R. Muijs, I. Kirenko, “A no-reference blocking artifact measure for adaptive video processing”, submitted to EUSIPCO 2005, 13nd Eur. Signal Proc. Conf. (Antalya, Turkey) and fully incorporated herein by reference. Discriminating averaging filters amenable to use in connection with one or more example embodiments described herein may be implemented in accordance with one or both U.S. Pat. No. 5,715,335 to de Haan et al, and to U.S. Pat. No. 7,162,099 to Ojo, et al., both of which, and any priority documents cited therein, are fully incorporated herein by reference.

In some embodiments, the spatial filters described in U.S. Pat. Nos. 5,715,335 and 7,162,099 are used to filter white Gaussian noise as well as digital coding artifacts as ringing and mosquito noise. The above grid-based horizontal and vertical low-pass filtering approach is applied with these noise and artifact filtering approaches, to facilitate desirable filtering of blocking artifacts and at the same time preserve sharpness and fine details. In some implementations, a low-pass filter is applied as a pre-filter, only on the pixels situated on the vertical and the horizontal grid and to the direct neighbors to reduce the blocking artifacts. Subsequently, a filter such as described in U.S. Pat. No. 7,162,099 is applied to reduce ringing and mosquito noise.

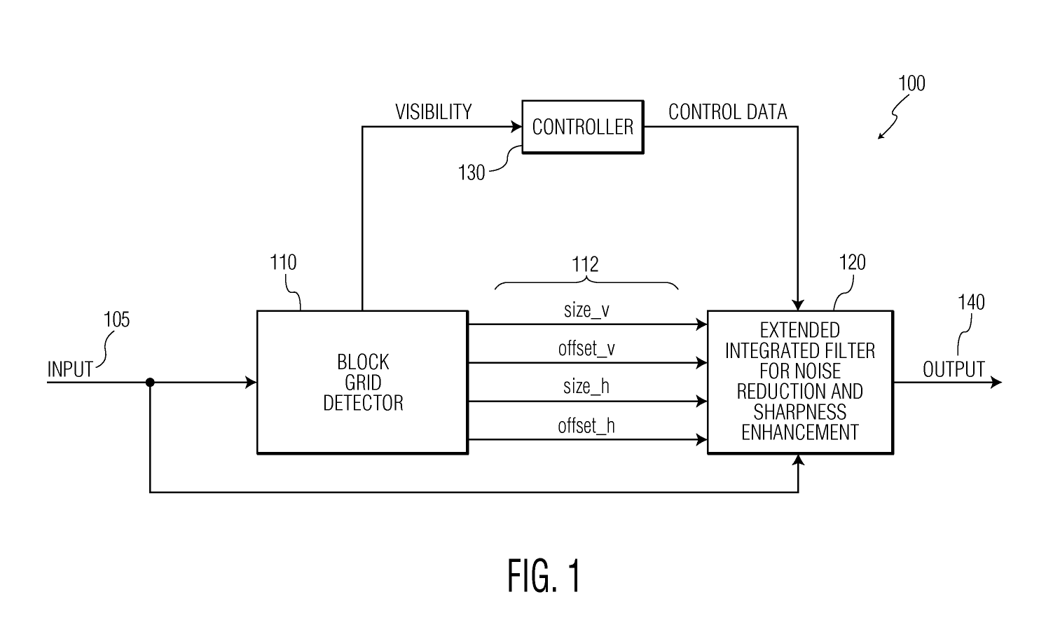

Turning now to the figures, FIG. 1 shows a system 100 for filtering video data, according to another example embodiment of the present invention. The system 100 includes a block grid detector 110, an extended integrated filter 120 and a controller 130. An input signal 105 is analyzed at the block grid detector 110, which generates information about the size and the offset of horizontal and vertical block edges in the input signal and, in some instances, generates information characterizing the visibility of artifacts. For instance, where the input video signal is a compressed bitstream, the detector 110 can detect the position of block grid data, provide a decoded video signal to the filter 120, and provide visibility data to the controller 130 by, for example, extracting and analyzing corresponding coding parameters from an input compressed bitstream.

The block grid detector 110 generates both horizontal and vertical size and offset data, which are provided to the integrated filter 120 at 112. The integrated filter 120 pre-filters pixels located on both sides of a horizontal or vertical block edge, using the information provided at 112. The input signal with pre-filtered pixels is then provided at an output 140, which can be provided to additional filtering processes (e.g., to a discriminating averaging filter as described above). In applications where the block grid detector 110 generates and/or extracts information about the visibility of artifacts in images corresponding to the input signal 105, the detector provides the visibility information to a controller 130 for controlling the extended integrated filter 120. This visibility information may, for example, provide an indication of artifact visibility to the human eye for the video data as it would be displayed. The controller 130 uses this information to generate and provide control data such as a filtering threshold, aperture size and shape, and/or strength of blurring to the filter 120.

In some embodiments, the block grid detector 110 performs local spatial analysis around a center pixel for the input signal 105 to differentiate regions of the image. This analysis may involve one or more of detecting spatial activity, the presence of object edges, analog noise, film grain or other image characteristics.

In a more particular approach, the block grid detector 110 performs local spatial analysis by differentiating three types of regions, respectively including high activity (texture) regions, flat regions and neighborhood of strong edges (e.g., as a potential source of ringing artifacts). The block grid detector 110 provides visibility data characterizing these types of regions (and corresponding artifact visibility) to the controller 130.

While shown as a single block, the block grid detector 110 may be implemented with separate components, such as to respectively perform block grid detection and local spatial analysis (e.g., the block grid detector 110 includes a detector circuit and a spatial analyzer circuit). In addition, the respective operations of the block grid detector 110 (as shown or separated) may be carried out on different domains. For instance, block grid detection can be carried out on a compressed bitstream, and local spatial analysis may be carried out upon raw pixel data. In this regard, the example block grid detector 110 shown in FIG. 1, as well as similar examples shown in the other figures (e.g., 210, 320), may be implemented with separate components or circuits.

For image regions near strong object edges or in flat areas, the controller 130 can set a filter threshold to a higher value, relative to the threshold as set for image regions exhibiting relatively high spatial activity. The threshold is correspondingly (and relatively) reduced in regions having strong object edges, where the visibility of a grid is generally lower due to a high local spatial activity of ringing or mosquito noise around the grid pixels. Other filtering parameters such as those described above may be similarly controlled to facilitate desirable video processing in each instance. This combination of using strong edge detection with a grid visibility metric (as provided by detector 110) is used to smooth image regions where ringing masks the block grid (i.e., reduces grid visibility).

In various example embodiments, the approaches described above and/or shown in FIG. 1 are applied to broadcast signals. For instance, where a digital television signal is broadcast over an analog channel, the above approach is implemented to mitigate noise corresponding to the analog transmission, while also mitigating digital artifacts. With this approach, undesirable image characteristics corresponding to both analog and digital are addressed, while maintaining desirable image quality.

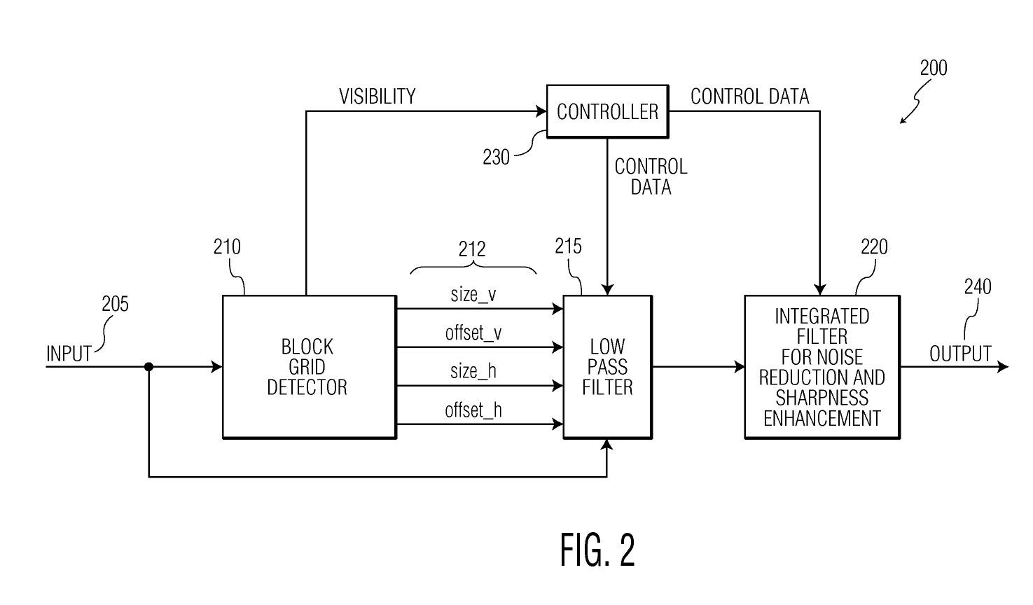

FIG. 2 shows another system 200 for filtering video data, according to another example embodiment of the present invention. The system 200 can be operated in a manner similar to that described above in connection with FIG. 1 and otherwise.

The system 200 includes a block grid detector 210, an extended integrated filter 220 and a controller 230 (e.g., similar to that described above), and further includes a low-pass filter 215. The block grid detector 210 generates information characterizing the visibility of artifacts in images corresponding to the input video signal 205 (e.g., a bitstream as described above), and provides that information to the controller 230. In response to the visibility information, the controller 230 generates a set of filter control parameters, and provides the parameters to the low-pass filter 215 and integrated filter 220.

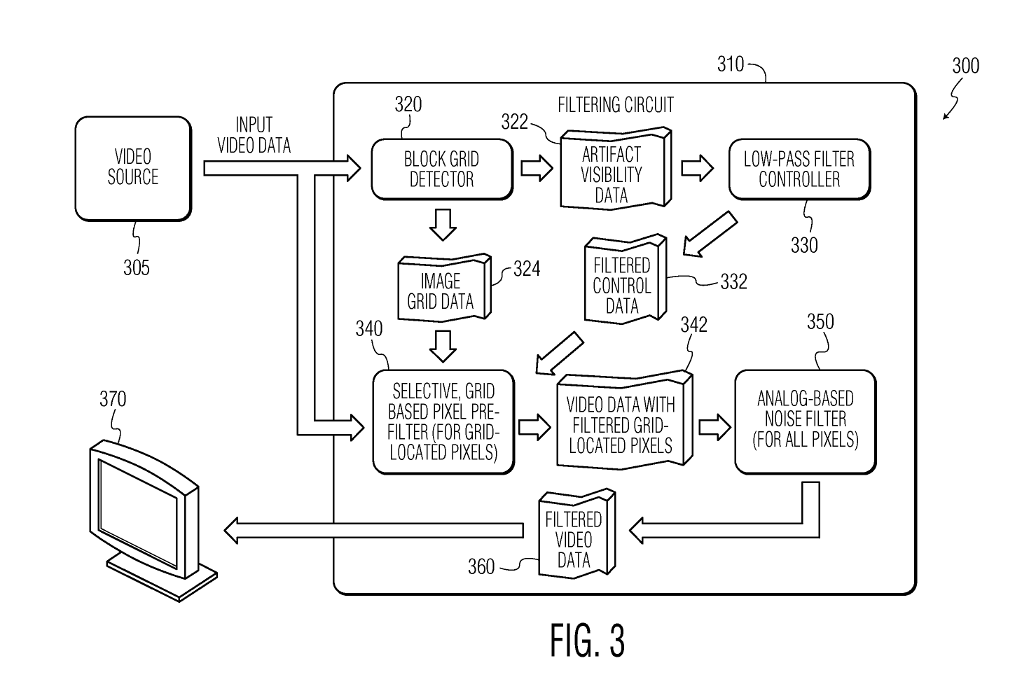

The block grid detector 210 generates both horizontal and vertical size and offset data (as above), which are provided at 212 to the low-pass filter 215. The low-pass filter 215 pre-filters pixels located on both sides of a horizontal or vertical block edge and passes these values to the integrated filter 220. The signal with filtered pixels is then provided at an output 240, which can be provided to additional filtering processes (e.g., to a discriminating averaging filter as described above). FIG. 3 shows a video processing and display system 300 for multi-stage, grid-based filtering of an incoming compressed video data bitstream from a video source 305, according to another example embodiment of the present invention. A filtering circuit 310 selectively pre-filters pixels of the bitstream that are located on or near grid lines to mitigate blocking (digital) artifacts, prior to filtering the incoming video data for noise.

The filtering circuit 310 includes a block grid detector 320 that identifies vertical and horizontal grid lines of an incoming video bitstream, decodes the compressed bitstream and provides the decoded bitstream and information regarding these grid lines to a filter 340. The block grid detector 320 also provides artifact visibility data 322 (e.g., as described above) to a low-pass filter controller 330, which uses the visibility data to generate filter control data 332 to control operational parameters of the filter 340 (e.g., to control parameters as relating to a threshold, aperture size and shape, strength of blurring or other characteristics).

The filter 340 passes pre-filtered video data 342 to a noise-based filter 350, which generally operates upon all of the pixels in the video data. The filtering circuit 310 provides the filtered output of the noise-based filter to a video display 370, which displays video using the filtered video data.

The system 300 can be implemented in a variety of manners. For example, in some applications, the filtering circuit 310 is integrated with the display 370. Certain applications are directed to using the display 370 to display broadcast video, such as digital video received over analog channels (i.e., where the video source 305 receives the data and converts it to digital data for processing).

In addition to the above, the various processing approaches described herein can be implemented using a variety of devices and methods including general purpose processors implementing specialized software, digital signal processors, programmable logic arrays, discrete logic components and fully-programmable and semi-programmable circuits such as PLAs (programmable logic arrays). For example, the above algorithms are executed on a microcomputer (a.k.a. microprocessor) in connection with certain embodiments, and as may be implemented as part of one or more of the devices shown in the figures.

While the present invention has been described above, in the figures and in the claims that follow, various systems and approaches may be implemented in connection with and/or in addition to the example embodiments described above. For instance, embodiments described in reference to the figures may be implemented using different systems and approaches. Embodiments described without specific reference to the figures may be implemented with the figures. Other embodiments involve using different filtering approaches in combination with those described, with mitigation of blocking artifacts. Still other embodiments involve using different sub-regions or pixels in filtering grid locations to mitigate blocking artifacts, such as by filtering a central as well as additional pixels within a predefined range of the central pixel (i.e., in addition to immediately adjacent pixels). In this regard, those skilled in the art will recognize that many changes may be made thereto without departing from the spirit and scope of the present invention.

Although the present invention has been illustrated and described with respect to several preferred embodiments thereof, various changes, omissions and additions to the form and detail thereof, may be made therein, without departing from the spirit and scope of the invention.

What is claimed is:

1. A method for processing video data representing images characterized by horizontal and vertical grids, the method comprising:
for each image, using a block grid detector to identify regions of the image that are centered on a horizontal grid or on a vertical grid; and
for each of the identified regions, filtering video data representing central sub-regions therein to mitigate blocking artifacts.

2. The method of claim 1, wherein filtering video data representing central sub-regions therein to mitigate blocking artifacts comprises
applying a horizontal low pass filter to video data representing a sub-region positioned on a vertical grid and sub-regions vertically adjacent the sub-region positioned on the vertical grid, and
applying a vertical low-pass filter to video data representing a sub-region positioned on a horizontal grid and sub-regions horizontally adjacent the sub-region positioned on the horizontal grid.

3. The method of claim 1, wherein filtering video data representing central sub-regions therein to mitigate blocking artifacts comprises
applying a horizontal low pass filter to video data representing a pixel positioned on a vertical grid and pixels immediately vertically adjacent the pixel positioned on the vertical grid, and
applying a vertical low-pass filter to video data representing a pixel positioned on a horizontal grid and pixels immediately horizontally adjacent the pixel positioned on the horizontal grid.

4. The method of claim 1, wherein
using a block grid detector to identify regions of the image that are centered on a horizontal grid or on a vertical grid comprises using the block grid detector to identify a region of the image that is centered on an intersection of a horizontal grid and a vertical grid, and
filtering video data representing central sub-regions therein to mitigate blocking artifacts includes, for the identified region, applying a low pass filter to video data representing a sub-region positioned on the intersection and sub-regions that are immediately horizontally or vertically adjacent thereto.

5. The method of claim 1, further comprising
replacing video data representing the identified regions with the filtered video data, and
after the step of replacing, filtering video data representing all of the regions of the image to reduce noise.

6. The method of claim 1, wherein
using a block grid detector to identify regions of the image that are centered on a horizontal grid or on a vertical grid comprises identifying pixel blocks having a central pixel that is centered on a horizontal grid or on a vertical grid, and
filtering video data representing central sub-regions therein to mitigate blocking artifacts comprises filtering video data representing the central pixel and pixels adjacent to the central pixel.

7. The method of claim 1,
wherein using a block grid detector to identify regions of the image that are centered on a horizontal grid or on a vertical grid comprises using the block grid detector to identify regions of the image that are centered on an intersection of a horizontal grid and a vertical grid,
wherein filtering video data representing central sub-regions therein to mitigate blocking artifacts comprises applying a low-pass filter to video data representing a center sub-region located on the intersection and to video data representing sub-regions that are immediately horizontally or vertically adjacent to the center sub-region, to mitigate digital artifacts, and
after the step of filtering video data representing central sub-regions therein to mitigate blocking artifacts, filtering the video data representing images to mitigate analog noise corresponding to the transmission of digital video on an analog channel.

8. The method of claim 1,
further comprising analyzing local spatial activity around the central sub-regions to identify three types of image regions including high spatial activity regions, flat regions, and regions adjacent object edges, and
wherein filtering video data representing central sub-regions therein to mitigate blocking artifacts comprises using a low pass filter operated at a low-pass filter threshold, the threshold being set to a high value for regions identified as adjacent object edges or as a flat region, and being set to a relatively lower value for image regions identified as exhibiting relatively high spatial activity.

9. The method of claim 1, wherein the video data is a compressed video bitstream, and using a block grid detector to identify regions of the image that are centered on a horizontal grid or on a vertical grid comprises identifying regions from the compressed video bitstream.

10. The method of claim 1,
further comprising
decoding the compressed video bitstream, and
generating filter control parameters from the decoded bitstream, and wherein
the video data is a compressed video bitstream,
using a block grid detector to identify regions of the image that are centered on a horizontal grid or on a vertical grid comprises identifying regions from the compressed video bitstream, and
filtering video data representing central sub-regions therein to mitigate blocking artifacts comprises filtering decoded video data from the decoded bitstream in response to the generated filter control parameters.

11. The method of claim 1,
further comprising performing local spatial analysis on each central sub-region to set filtering parameters, and
wherein filtering video data representing central sub-regions therein to mitigate blocking artifacts comprises filtering said video data using the set filtering parameters.

12. A system for processing video data representing images characterized by horizontal and vertical grids, the system comprising:
a block grid detector to identify regions of each image that are centered on a horizontal grid or on a vertical grid;
and a filter to filter video data representing central sub-regions within each identified region to mitigate blocking artifacts therein.

13. The system of claim 12, wherein
the block grid detector detects information regarding the visibility of artifacts in each image, and
the filter
comprises a controller that sets filter parameters in response to detected artifact visibility information, and
filters video data from the block grid detector using the set filter parameters.

14. The system of claim 12, wherein the filter comprises
a horizontal low pass filter that filters video data representing a sub-region positioned on a vertical grid and sub-regions vertically adjacent the sub-region positioned on the vertical grid, and
a vertical low-pass filter that filters video data representing a sub-region positioned on a horizontal grid and sub-regions horizontally adjacent the sub-region positioned on the horizontal grid.

15. The system of claim 12, wherein
the block grid detector identifies regions of each image that are centered on an intersection of a horizontal grid and a vertical grid, and
the filter comprises a low pass filter to filter video data, in the identified regions, representing a sub-region therein positioned on the intersection and sub-regions therein that are horizontally or vertically adjacent thereto.

16. The system of claim 12, wherein the filter replaces video data representing the identified regions with the filtered video data to provide a pre-filtered video stream, further comprising a secondary noise-reduction filter to filter all regions of images in the pre-filtered video stream.

17. The system of claim 12, further comprising a local spatial analysis arrangement to detect artifact conditions for each central sub-region, wherein the filter arrangement uses filtering parameters, set in response to the detected artifact conditions, to mitigate blocking artifacts.

18. A system for processing a compressed video bitstream for video data characterized by horizontal and vertical grids, the system comprising:
a block grid detector to identify horizontal and vertical grids from the bitstream, to decode the bitstream, and to output decoded video data together with information characterizing the identified grids;
a spatial analyzer to detect artifact conditions for each pixel block centered on one of the identified grids;
a pre-filter to use the identified grids and detected artifact conditions to pre-filter the pixel blocks that are centered on a grid to mitigate blocking artifacts therein; and
a secondary filter to receive an output from the pre-filter and to filter the decoded pre-filtered video data.

19. The system of claim 18, wherein the spatial analyzer detects artifact conditions comprising at least one of local spatial activity, the presence of object edges, the direction of object edges, analog noise and film grain.

20. The system of claim 18, wherein the pre-filter comprises a controller and a filter, the controller being coupled to receive the detected artifact conditions from the spatial analyzer and to use the detected conditions to generate a set of control parameters that are used by the filter to pre-filter the pixel blocks.
